(19) United States
(12) Patent Application Publication
(10) Pub. No.: US 2026/0281763 A1
(43) Pub. Date: Sep. 17, 2026

(54) USING WIDE BEAM SYNCHRONIZATION SIGNAL BLOCK (SSB) MEASUREMENTS TO PREDICT NARROW BEAM SSBS

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/474,107

(22) PCT Filed: Jun. 8, 2023
(86) PCT No.: PCT/CN2023/099066

§ 371 Date: Oct. 9, 2025

(51) Int. Cl. H04W 24/08; H04W 74/0833

(52) U.S. Cl. CPC H04W 24/08; H04W 74/0833

(57) ABSTRACT

Various aspects of the present disclosure generally relate to wireless communication. In some aspects, a user equipment (UE) may receive a synchronization signal block (SSB) burst that includes a first set of SSBs. The UE may perform measurements associated with the SSB burst. The UE may determine linkage information between the first set of SSBs and a second set of SSBs. The UE may determine a random access channel (RACH) configuration associated with the second set of SSBs. The UE may determine, based at least in part on the measurements, the linkage information and the RACH configuration, a predicted best SSB from the second set of SSBs and a random access channel (RACH) resource associated with the predicted best SSB. The UE may transmit a RACH message based at least in part on the predicted best SSB and the RACH resource. Numerous other aspects are described.

### FIELD OF THE DISCLOSURE

Aspects of the present disclosure generally relate to wireless communication and to techniques and apparatuses for using wide beam synchronization signal block (SSB) measurements to predict narrow beam SSBs.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes one or more memories and one or more processors coupled to the one or more memories, the one or more processors individually or collectively configured to: receive a plurality of synchronization signal block (SSB) bursts, wherein an SSB burst of the plurality of SSB bursts includes a first set of SSBs and one or more repetitions of the first set of SSBs; perform measurements associated with the plurality of SSB bursts; determine linkage information between the first set of SSBs and a second set of SSBs, wherein the second set of SSBs are associated with resources not actually transmitted; determine a random access channel (RACH) configuration associated with the second set of SSBs; determine, based at least in part on the measurements, the linkage information, and the RACH configuration, a predicted best SSB from the second set of SSBs and a RACH resource associated with the predicted best SSB; and transmit a RACH message based at least in part on the predicted best SSB and the RACH resource.

In some implementations, a method of wireless communication performed by a UE includes receiving a plurality of SSB bursts, wherein an SSB burst of the plurality of SSB bursts includes a first set of SSBs and one or more repetitions of the first set of SSBs; performing measurements associated with the plurality of SSB bursts; determining linkage information between the first set of SSBs and a second set of SSBs, wherein the second set of SSBs are associated with resources not actually transmitted; determining a random access channel (RACH) configuration associated with the second set of SSBs; determining, based at least in part on the measurements, the linkage information, and the RACH configuration, a predicted best SSB from the second set of SSBs and a RACH resource associated with the predicted best SSB; and transmitting a RACH message based at least in part on the predicted best SSB and the RACH resource.

In some implementations, a non-transitory computer-readable medium storing a set of instructions for wireless communication includes one or more instructions that, when executed by one or more processors of a UE, cause the UE to: receive a plurality of SSB bursts, wherein an SSB burst of the plurality of SSB bursts includes a first set of SSBs and one or more repetitions of the first set of SSBs; perform measurements associated with the plurality of SSB bursts; determine linkage information between the first set of SSBs and a second set of SSBs; determine, based at least in part on the measurements and the linkage information, a predicted best SSB from the second set of SSBs and a RACH resource associated with the predicted best SSB; and transmit a RACH message based at least in part on the predicted best SSB and the RACH resource.

In some implementations, an apparatus for wireless communication includes means for receiving a plurality of SSB bursts, wherein an SSB burst of the plurality of SSB bursts includes a first set of SSBs and one or more repetitions of the first set of SSBs; means for performing measurements associated with the plurality of SSB bursts; means for determining linkage information between the first set of SSBs and a second set of SSBs, wherein the second set of SSBs are associated with resources not actually transmitted; means for determining a random access channel (RACH) configuration associated with the second set of SSBs; means for determining, based at least in part on the measurements, the linkage information, and the RACH configuration, a predicted best SSB from the second set of SSBs and a RACH resource associated with the predicted best SSB; and means for transmitting a RACH message based at least in part on the predicted best SSB and the RACH resource.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of beam management, in accordance with the present disclosure.

FIG. 5 is a diagram illustrating an example of a random access channel (RACH) configuration for establishing a secondary cell group (SCG), in accordance with the present disclosure.

FIG. 6 is a diagram illustrating an example of beam sweeping, in accordance with the present disclosure.

FIGS. 7-12 are diagrams illustrating examples associated with using wide beam synchronization signal block (SSB) measurements to predict narrow beam SSBs, in accordance with the present disclosure.

FIG. 13 is a diagram illustrating an example process associated with using wide beam SSB measurements to predict narrow beam SSBs, in accordance with the present disclosure.

FIG. 14 is a diagram of an example apparatus for wireless communication, in accordance with the present disclosure.

### DETAILED DESCRIPTION

A network node may transmit a plurality of synchronization signal block (SSB) bursts, where each SSB burst may be associated with M₁ narrow beams. The network node may transmit the plurality of SSB bursts via a relatively brute-force beam sweeping. A user equipment (UE) may perform M₁×N measurements over N SSB cycles. The measurements may be layer 1 reference signal received power (L1-RSRP) SSB measurements (e.g., filtered L1-RSRP SSB measurements). The UE may identify appropriate receive (Rx) beams for each SSB burst of the plurality of SSB bursts, which may be based at least in part on L1-RSRP SSB measurements. The UE may determine, based at least in part on the L1-RSRP SSB measurements, a best narrow beam SSB and an associated random access channel (RACH) resource. The UE may transmit a RACH message, using the RACH resource, based at least in part on the best narrow beam SSB.

However, a secondary cell group (SCG) setup may be relatively slow due to the relatively large number of L1-RSRP SSB measurements needed to be performed by the UE. Measuring the plurality of SSB bursts for the SCG setup may be power and latency consuming for the UE, thereby degrading a UE performance.

Various aspects relate generally to using wide beam SSB measurements to predict narrow beam SSBs for relatively fast SCG setup. Some aspects more specifically relate to using an SSB burst specific beam repetition pattern and an associated RACH configuration when using the wide beam SSB measurements to predict the narrow beam SSBs. In some examples, a UE may receive, from a network node, a plurality of SSB bursts. An SSB burst of the plurality of SSB bursts may include a first set of SSBs and one or more repetitions of the first set of SSBs. The one or more repetitions of the first set of SSBs may be based at least in part on the SSB burst specific beam repetition pattern. The UE may perform measurements (e.g., L1-RSRP measurements) associated with the plurality of SSB bursts. The UE may determine linkage information between the first set of SSBs and a second set of SSBs. The second set of SSBs may be associated with resources (e.g., virtual resources) that are not actually transmitted. The first set of SSBs may be associated with wider SSB beams as compared to SSB beams associated with the second set of SSBs. For example, the first set of SSBs may be associated with wide beam SSBs and the second set of SSBs may be associated with narrow beam SSBs. The UE may determine a RACH configuration associated with the second set of SSBs. The UE may determine, based at least in part on the measurements, the linkage information and the RACH configuration, a predicted best SSB from the second set of SSBs and a RACH resource associated with the predicted best SSB. The RACH resource may be based at least in part on the RACH configuration associated with the SSB burst specific beam repetition pattern. The UE may transmit, to the network node, a RACH message based at least in part on the predicted best SSB and the RACH resource.

Particular aspects of the subject matter described in this disclosure can be implemented to realize one or more of the following potential advantages. In some examples, by using the wide beam SSB measurements to predict the narrow beam SSBs, the described techniques can be used to achieve the relatively fast SCG setup. The SSB burst beam repetition pattern and the associated RACH configuration may reduce both latency and a number of UE measurements (e.g., L1-RSRP SSB measurements), as compared to a brute-force beam sweeping that involves transmitting the plurality of SSB bursts associated with narrow beams, thereby improving an overall performance of the UE. For example, the SSB burst beam repetition pattern may reduce the latency and the number of UE measurements by approximately 50%, as compared to the brute-force beam sweeping, which may improve the performance of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

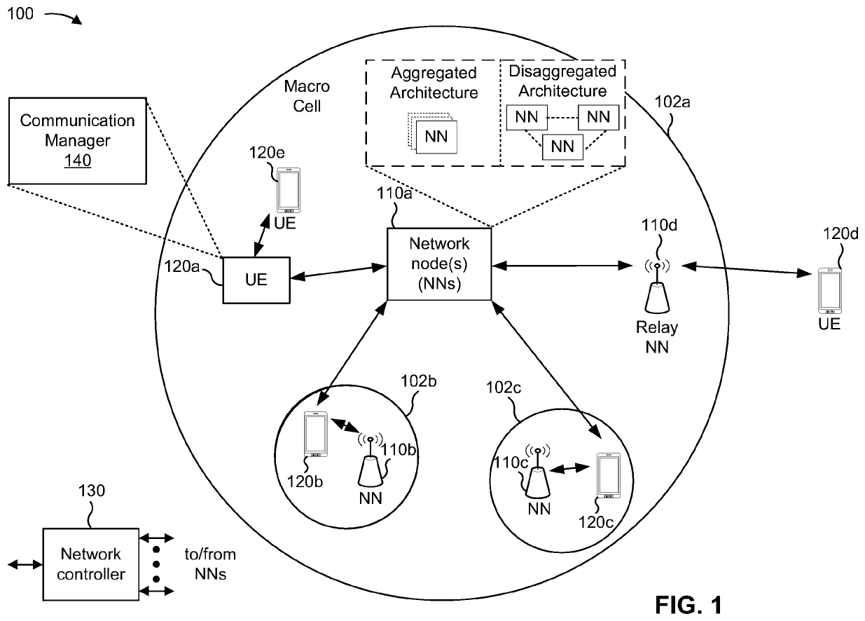

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive a plurality of SSB bursts, wherein an SSB burst of the plurality of SSB bursts includes a first set of SSBs and one or more repetitions of the first set of SSBs; perform measurements associated with the plurality of SSB bursts; determine linkage information between the first set of SSBs and a second set of SSBs, wherein the second set of SSBs are associated with resources not actually transmitted; determine a random access channel (RACH) configuration associated with the second set of SSBs; determine, based at least in part on the measurements, the linkage information, and the RACH configuration, a predicted best SSB from the second set of SSBs and a RACH resource associated with the predicted best SSB; and transmit a RACH message based at least in part on the predicted best SSB and the RACH resource. Additionally, or alternatively, the communication manager 140 may perform one or more other operations described herein.

As indicated above, FIG. 1 is provided as an example. Other examples may differ from what is described with regard to FIG. 1.

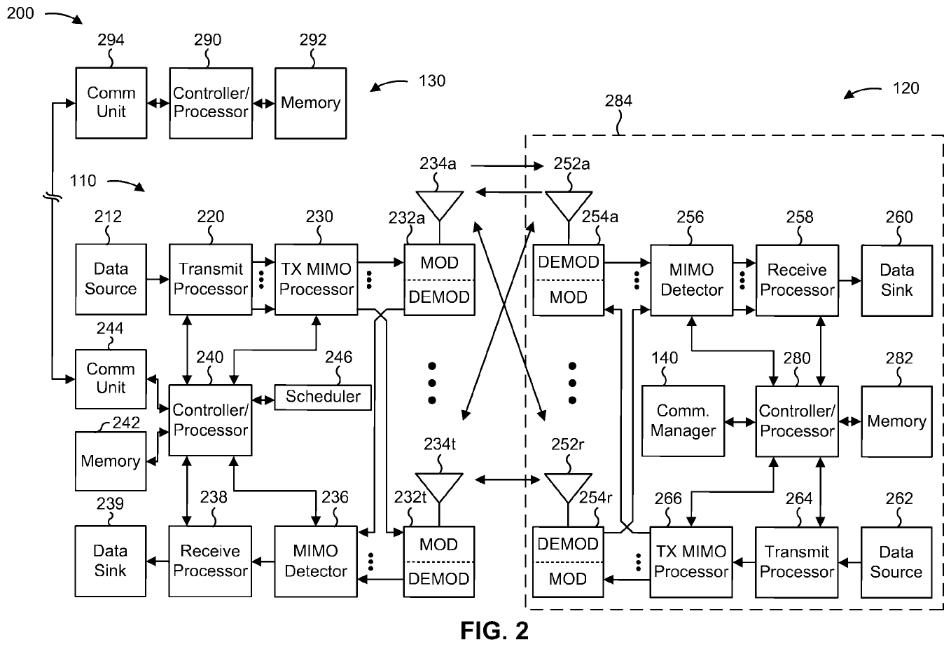

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

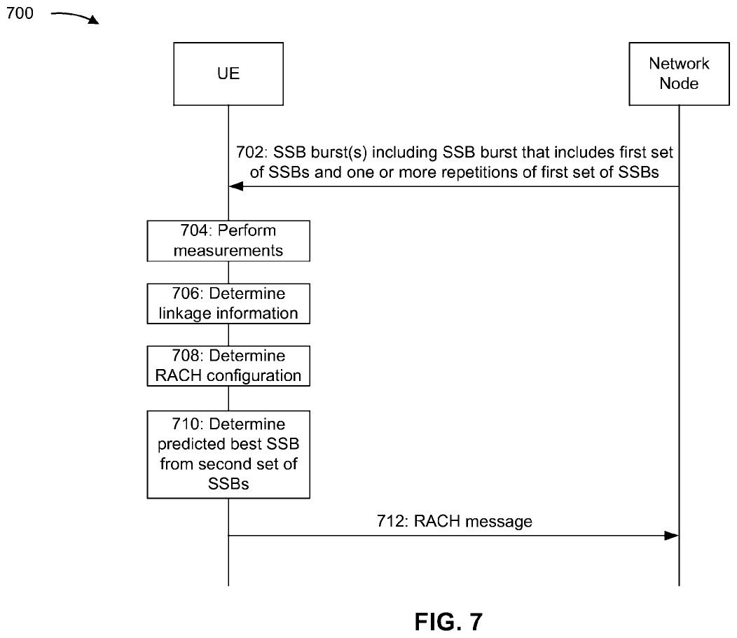

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the Tx MIMO processor 266. The transceiver may be used by a processor (e.g., the controller/processor 280) and the memory 282 to perform aspects of any of the methods described herein (e.g., with reference to FIGS. 7-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the Tx MIMO processor 230. The transceiver may be used by a processor (e.g., the controller/processor 240) and the memory 242 to perform aspects of any of the methods described herein (e.g., with reference to FIGS. 7-14).

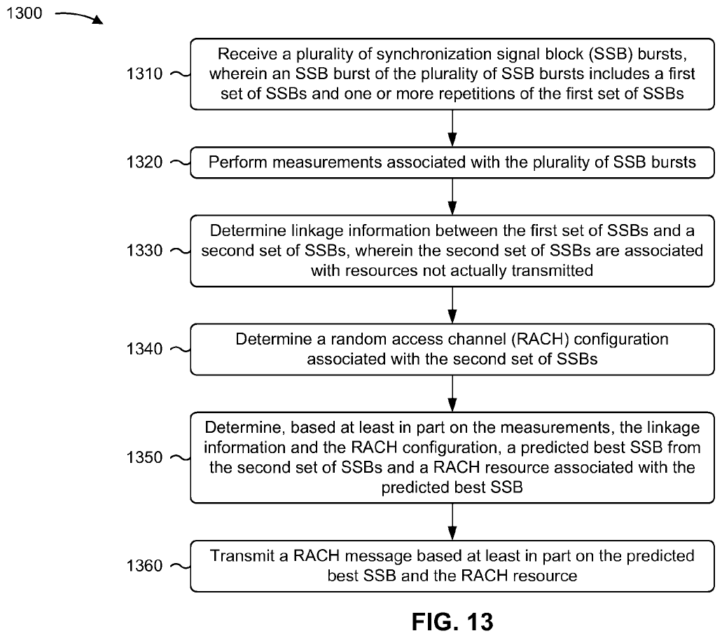

The controller/processor 240 of the network node 110, the controller/processor 280 of the UE 120, and/or any other component(s) of FIG. 2 may perform one or more techniques associated with using wide beam SSB measurements to predict narrow beam SSBs, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a plurality of SSB bursts, wherein an SSB burst of the plurality of SSB bursts includes a first set of SSBs and one or more repetitions of the first set of SSBs; means for performing measurements associated with the plurality of SSB bursts; means for determining linkage information between the first set of SSBs and a second set of SSBs, wherein the second set of SSBs are associated with resources not actually transmitted; means for determining a random access channel (RACH) configuration associated with the second set of SSBs; means for determining, based at least in part on the measurements, the linkage information, and the RACH configuration, a predicted best SSB from the second set of SSBs and a RACH resource associated with the predicted best SSB; and/or means for transmitting a RACH message based at least in part on the predicted best SSB and the RACH resource. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

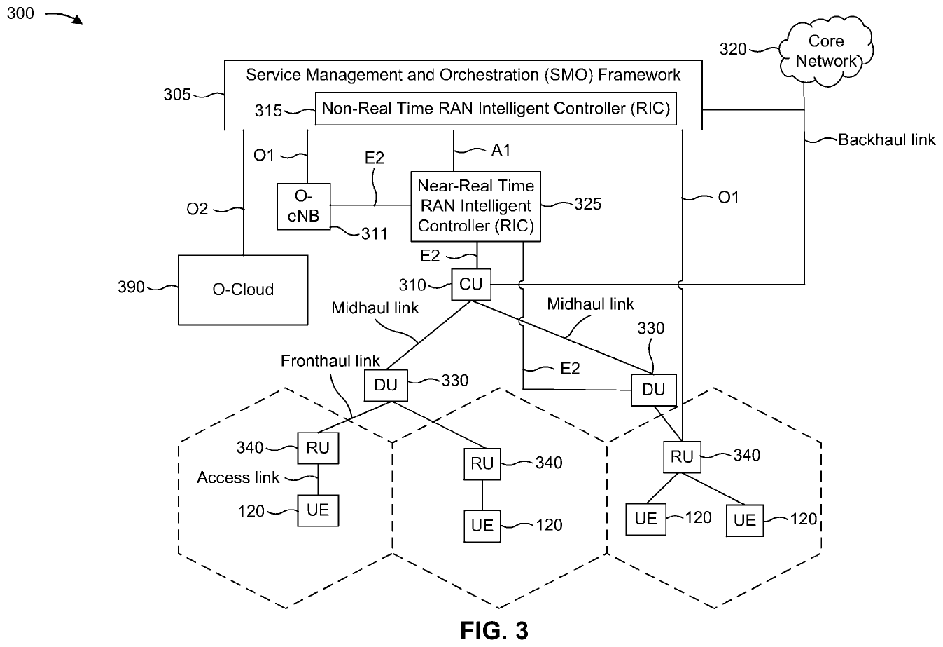

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

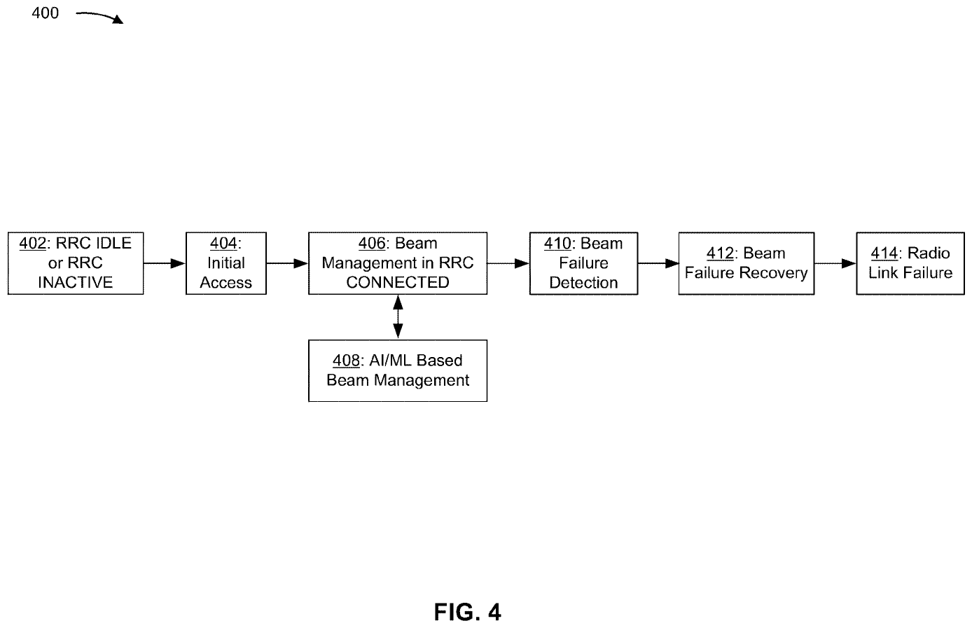

FIG. 4 is a diagram illustrating an example 400 of beam management, in accordance with the present disclosure.

As shown by reference number 402, a UE may initially be in an RRC idle state or an RRC inactive state. As shown by reference number 404, the UE may perform an initial access. As shown by reference number 406, the UE may perform a beam management after entering an RRC connected state. The beam management may include P1, P2, and/or P3 beam management procedures. The P1 beam management procedure may be a beam selection procedure, an initial beam acquisition procedure, a beam sweeping procedure, a cell search procedure, and/or a beam search procedure. The P2 beam management procedure may be a beam refinement procedure, a network node beam refinement procedure, a TRP beam refinement procedure, and/or a Tx beam refinement procedure. The P3 beam management procedure may be a beam refinement procedure, a UE beam refinement procedure, and/or an Rx beam refinement procedure. As shown by reference number 408, the UE may also perform beam management using an AI/ML-based approach. The beam management using the AI/ML-based approach may use an AI/ML model in a spatial domain (SD), a time domain (TD), and/or a frequency domain (FD), which may reduce signaling overhead and latency and improve a beam selection accuracy. The AI/ML model may be associated with a lifecycle management, which may involve a model training, model deployment, model inference, model monitoring, and/or model updating. As shown by reference number 410, the UE may perform a beam failure detection (BFD), which may be based at least in part on measurements obtained during the beam management after entering the RRC connected mode. As shown by reference number 412, the UE may perform a beam failure recovery (BFR) based at least in part on the BFD. As shown by reference number 414, when the BFR is not successful, the UE may declare a radio link failure (RLF).

As indicated above, FIG. 4 is provided as an example. Other examples may differ from what is described with regard to FIG. 4.

For an AI/ML-based beam management, a first beam management case and a second beam management case may be supported for characterization and baseline performance evaluations. The first beam management case may involve an SD downlink beam prediction for a first set of beams (Set A) based at least in part on measurement results of a second set of beams (Set B). The second beam management case may involve a temporal downlink beam prediction for the first set of beams based at least in part on historical measurement results of the second set of beams. For the first beam management case and the second beam management case, beams in the first set of beams and beams in the second set of beams may be in the same frequency range.

In the first beam management case, in a first alternative, the second set of beams may be a subset of the first set of beams. In the first alternative, the first set of beams and the second set of beams may each be associated with a defined quantity of beams. The second set of beams may be determined from beams in the first set of beams based at least in part on a fixed pattern or a random pattern. In a second alternative, the first set of beams may be different from the second set of beams (e.g., the first set of beams may include narrow beams and the second set of beams may include wide beams). In the second alternative, the first set of beams and the second set of beams may each be associated with a defined quantity of beams. A quasi co-location (QCL) relation may be defined between beams in the first set of beams and beams in the second set of beams. Further, the first set of beams may be for downlink beam prediction, and the second set of beams may be for downlink beam measurement.

For the first beam management case and with a UE-side AI/ML model, layer 1 (L1) signaling may be used to report information associated with an AI/ML model inference to a network node. The information may indicate one or more beams (e.g., reported beams) that are based at least in part on an output of the AI/ML model inference. The information may indicate predicted L1-RSRP measurements corresponding to the one or more beams.

For the second beam management case and with the UE-side AI/ML model, L1 signaling may be used to report information associated with the AI/ML model inference to the network node. The information may indicate one or more beams of N upcoming time instances, where the one or more beams may be based at least in part on the output of the AI/ML model inference. A value for N may be defined. The information may indicate predicted L1-RSRP measurements corresponding to the one or more beams. The information may indicate a timestamp corresponding to the one or more beams, where the timestamp may be indicated explicitly or implicitly.

For the first and second beam management cases with the UE-side AI/ML model, a model monitoring may be employed. For a UE-side model monitoring, the UE may monitor performance metrics. The UE may perform decisions of model selection, activation, deactivation, switching, or fallback operation based at least in part on the performance metrics. For a network-side model monitoring, the network node may monitor performance metrics. The network node may perform decisions of model selection, activation, deactivation, switching, or fallback operation based at least in part on the performance metrics. In a hybrid model monitoring, the UE may monitor performance metrics, and the network node may perform decisions of model selection, activation, deactivation, switching, or fallback operation based at least in part on the performance metrics.

For the first and second beam management cases with a network-side AI/ML model, the network-side model monitoring may be employed. The network node may monitor the performance metrics, and the network node may perform decisions of model selection, activation, deactivation, switching, or fallback operation based at least in part on the performance metrics. For the first and second beam management cases with the network-side AI/ML model, a beam measurement and report for model monitoring may be employed. For the first and second beam management cases with the network-side AI/ML model, the UE may report measurement results of more than four beams in one reporting instance based at least in part on an L1 beam reporting for the AI/ML model inference.

A serving cell configuration common (ServingCellConfigCommon) information element (IE) may be used to provide dedicated signaling when configuring a UE with an SCG. The serving cell configuration common IE may contain its own RACH configuration, such as a RACH configuration common (RACH-ConfigCommon). The RACH configuration common may provide information for an initial access procedure.

As an example, a UE may have an RRC configuration based at least in part on a serving cell #0 in FR1. The UE may be additionally configured with a serving cell #1, via a serving cell configuration common IE, in FR2. The UE may measure SSBs in serving cell #1. The UE may perform a RACH procedure based at least in part on a RACH configuration common for contention based random access (CBRA) or a RACH configuration common for contention free random access (CFRA), which may be configured in serving cell #1. The UE may obtain a relatively large amount of SSB measurements during a P1 procedure for beam management in FR2.

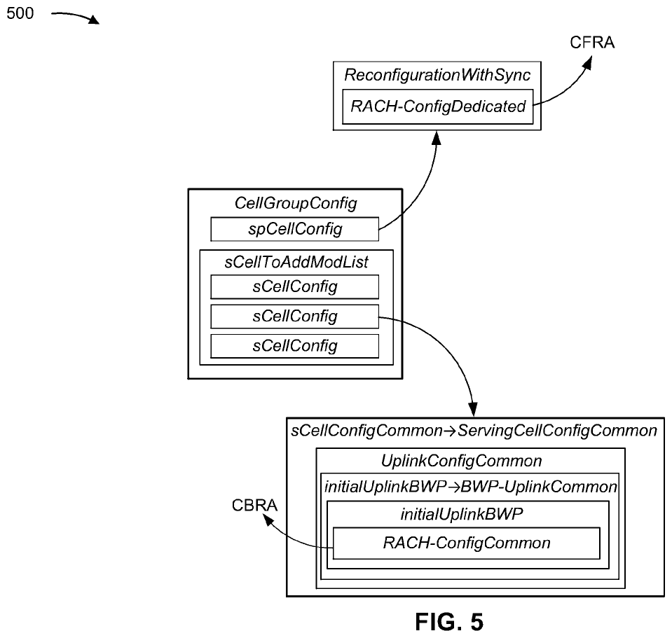

FIG. 5 is a diagram illustrating an example 500 of a RACH configuration for establishing an SCG, in accordance with the present disclosure.

As shown in FIG. 5, a cell group configuration (CellGroupConfig) may include a special cell configuration (spCellConfig) and a secondary cell to add or modify list (sCellToAddModList). The special cell configuration may include a RACH configuration dedicated (RACH-ConfigDedicated) IE, which may be associated with CFRA. The RACH configuration dedicated IE may be associated with a reconfiguration with synchronization (ReconfigurationWithSync) IE. The secondary cell to add or modify list may include one or more secondary cell configurations (sCellConfig). A secondary cell configuration, of the one or more secondary cell configurations, may include a serving cell configuration common (ServingCellConfigCommon) IE. The serving cell configuration common IE may include an uplink configuration common (UplinkConfigCommon) IE. The uplink configuration common may be associated with an initial uplink bandwidth part (BWP) (initialUplinkBWP) IE, which may be associated with a BWP uplink common (BWP-UplinkCommon) IE. The initial uplink BWP IE may be associated with a RACH configuration common (RACH-ConfigCommon) IE, which may be associated with CBRA.

As indicated above, FIG. 5 is provided as an example. Other examples may differ from what is described with regard to FIG. 5.

Remaining minimum system information (RMSI) for initial access or a serving cell configuration common IE may indicate an SSB position in burst (ssb-PositionInBurst) IE, which may identify TD locations of actually transmitted SSBs. The TD locations of the actually transmitted SSBs may be indicated using an 8-bit or 16-bit bitmap. In other words, the actually transmitted SSBs may be identified from the SSB position in burst IE in the RMSI or in the serving cell configuration common IE. For sub-6 GHz, in which a quantity of SSBs is up to 8, a full bitmap (e.g., 8 bits) may be used for an indication of actual SSB transmissions. For above-6 GHz, in which a quantity of SSBs is up to 64, a group-bitmap (e.g., 8 bits) and a bitmap in group (e.g., 8 bits) may be used. A group may be defined as consecutive SSBs. A bitmap in group may indicate which SSB is actually transmitted within a group, where each group may have the same pattern of SSB transmission. A group-bitmap may indicate which group is actually transmitted.

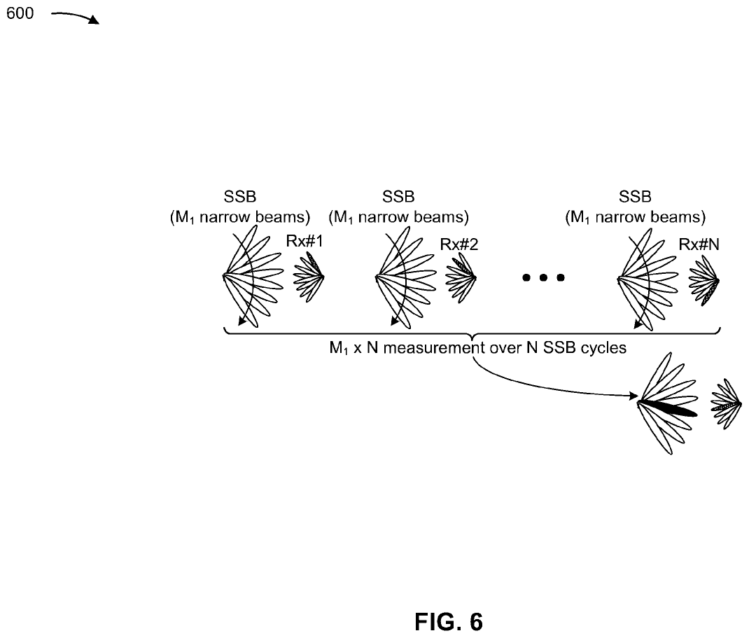

FIG. 6 is a diagram illustrating an example 600 of beam sweeping, in accordance with the present disclosure.

As shown in FIG. 6, a network node may transmit a plurality of SSB bursts, where each SSB burst may be associated with M₁ narrow beams. The network node may transmit the plurality of SSB bursts via a relatively brute-force beam sweeping. The UE may perform M₁×N measurements (e.g., filtered L1-RSRP SSB measurements) over N SSB cycles. The UE may identify appropriate Rx beams for each SSB burst of the plurality of SSB bursts (e.g., Rx#1 for a first SSB burst, Rx#2 for a second SSB burst, and Rx#N for an Nth SSB burst), which may be based at least in part on L1-RSRP SSB measurements. The UE may determine, based at least in part on the L1-RSRP SSB measurements, a best narrow beam SSB and an associated RACH resource. The UE may transmit a RACH message, using the RACH resource, based at least in part on the best narrow beam SSB.

However, an SCG setup may be relatively slow due to the relatively large number of L1-RSRP SSB measurements needed to be performed by the UE. Measuring the plurality of SSB bursts in FR2 for the SCG setup may be power and latency consuming for the UE, thereby degrading a UE performance.

As indicated above, FIG. 6 is provided as an example. Other examples may differ from what is described with regard to FIG. 6.

In various aspects of techniques and apparatuses described herein, a UE may receive, from a network node, a plurality of SSB bursts. An SSB burst of the plurality of SSB bursts may include a first set of SSBs and one or more repetitions of the first set of SSB. The UE may perform measurements (e.g., L1-RSRP measurements) associated with the plurality of SSB bursts. The UE may determine linkage information between the first set of SSBs and a second set of SSBs. The second set of SSBs may be associated with resources (e.g., virtual resources) that are not actually transmitted. For example, the second set of SSBs may not actually be transmitted by the network node. The SSBs of the second set of SSBs may not be transmitted. In other words, not only are the SSBs associated with virtual/un-transmitted resources, but the SSBs themselves may not be transmitted. The first set of SSBs may be associated with wider SSB beams as compared to SSB beams associated with the second set of SSBs. For example, the first set of SSBs may be associated with wide beam SSBs and the second set of SSBs may be associated with narrow beam SSBs. The UE may determine a RACH configuration associated with the second set of SSBs. The UE may determine, based at least in part on the measurements, the linkage information and the RACH configuration, a predicted best SSB from the second set of SSBs and a RACH resource associated with the predicted best SSB. The UE may transmit, to the network node, a RACH message based at least in part on the predicted best SSB and the RACH resource.

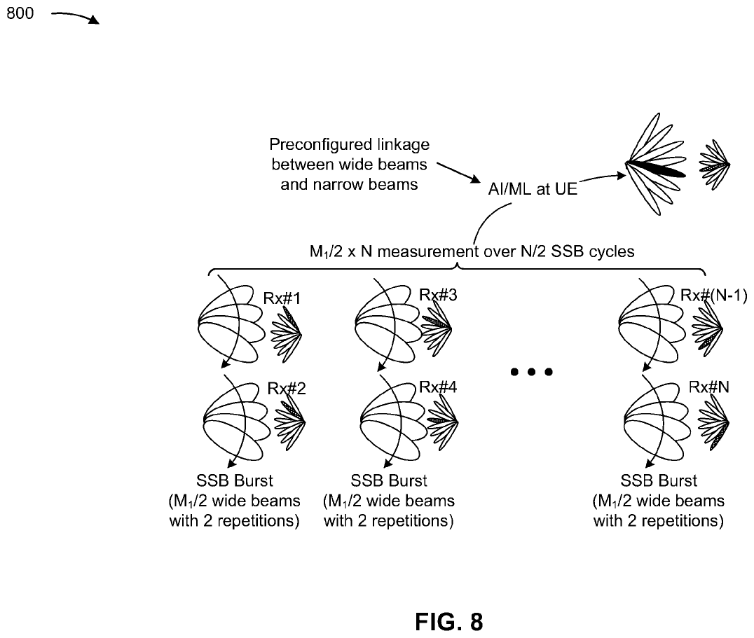

In some aspects, wide beam SSB measurements may be used to predict narrow beam SSBs for relatively fast SCG setup (e.g., as shown in FIG. 8). Wide beams may be Set B beams (e.g., measurement resources), while narrow beams may be Set A beams (e.g., prediction targets). The wide beams may be associated with the first set of SSBs (e.g., Set B SSBs), and the narrow beams may be associated with the second set of SSBs (e.g., Set A SSBs). Linkages between wide beams and narrow beams may be RRC configured. SSBs transmitted in a single SSB burst may be based at least in part on repetitive Tx beams, which may reduce latency for a UE Rx beam determination. The UE may measure wide beam SSBs (e.g., the first set of SSBs) received from the network node. The UE may use AI/ML to predict a best narrow beam SSB and an associated RACH resource, which may be based at least in part on the measured wide beam SSBs and the linkages between wide beams and narrow beams. The UE may transmit, to the network node, the RACH message using the RACH resource and based at least in part on the predicted best narrow beam SSB. By predicting the narrow beam SSBs from the wide beam SSB measurements, the relatively fast SCG setup may be achieved. An SSB burst beam repetition pattern and an associated RACH configuration may be implemented to achieve the relatively fast SCG setup. The SSB burst beam repetition pattern and the associated RACH configuration may reduce both latency and a number of UE measurements, as compared to a brute-force beam sweeping that involves transmitting the plurality of SSB bursts associated with narrow beams, thereby improving an overall performance of the UE.

FIG. 7 is a diagram illustrating an example 700 associated with using wide beam SSB measurements to predict narrow beam SSBs, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may receive, from the network node, a plurality of SSB bursts. An SSB burst (e.g., each SSB burst) of the plurality of SSB bursts may include a first set of SSBs and one or more repetitions of the first set of SSBs. The first set of SSBs may be associated with wide beam SSBs. The first set of SSBs may be associated with transmitted SSBs for a serving cell (e.g., actually transmitted SSBs for the serving cell). The first set of SSBs may be identified via an SSB position in burst IE in RMSI or a serving cell configuration common IE associated with the serving cell. In some cases, the SSB burst may include a third set of SSBs, which may also be associated with wide beam SSBs. The third set of SSBs may include the one or more repetitions of the first set of SSBs (e.g., in an SD).

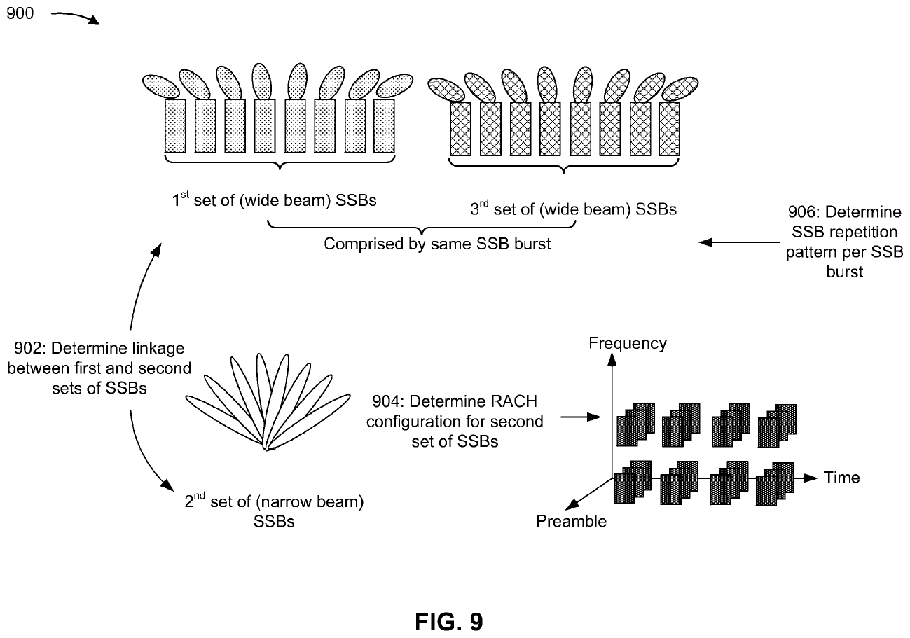

In some aspects, an SSB burst specific beam repetition pattern configuration may be defined. Actually transmitted SSBs regarding a certain serving cell (ServCell) may be defined as the first set of SSBs (e.g., as shown in FIG. 9) for the serving cell, where the actually transmitted SSBs may be identified via the SSB position in burst IE from RMSI or the serving cell configuration common IE associated with the serving cell (e.g., a candidate serving cell). The actually transmitted SSBs may be associated with wide beams.

As shown by reference number 704, the UE may perform measurements associated with the plurality of SSB bursts. For example, the UE may perform L1-RSRP measurements associated with the plurality of SSB bursts. The UE may perform the measurements with lower latency due to the third set of SSBs including the one or more repetitions of the first set of SSBs in the SD (e.g., SSBs transmitted in a single SSB burst may be based at least in part on repetitive transmit beams). Further, the UE may perform fewer measurements because a number of wide beam measurements may be less than a number of narrow beam measurements.

As shown by reference number 706, the UE may determine linkage information between the first set of SSBs and a second set of SSBs. The second set of SSBs may be associated with resources (e.g., virtual resources) that are not actually transmitted. The first set of SSBs may be associated with wider SSB beams as compared to SSB beams associated with the second set of SSBs. For example, the second set of SSBs may be associated with narrow beam SSBs. The second set of SSBs may be associated with virtual and not transmitted SSBs (e.g., virtual and not actually transmitted SSBs). The UE may determine the linkage from the SSB position in burst IE in RMSI, the serving cell configuration common IE, or a serving cell configuration (ServingCellConfig) associated with the serving cell. The linkage information indicates a linkage between the first set of SSBs and the second set of SSBs in terms of beam pointing directions, beam widths, or other implicit linkages.

In some aspects, the UE may identify, via the RMSI, the serving cell configuration common IE, or the serving cell configuration associated with the serving cell, the linkage information describing a linkage between the first set of SSBs and the second set of SSBs (e.g., as shown in FIG. 9). The first set of SSBs may be Set B SSBs. The second set of SSBs may be Set A SSBs. The second set of SSBs may be associated with virtual and not actually transmitted SSBs. The second set of SSBs may be associated with narrow beams. The linkage information between the first set of SSBs and the second set of SSBs may be in terms of the beam pointing directions, the beam widths, and/or the other implicit linkages (e.g., linear combination or beam neighboring).

As shown by reference number 708, the UE may determine a RACH configuration associated with the second set of SSBs. The UE may determine the RACH configuration from the SSB position in burst IE in the RMSI, the serving cell configuration common IE, or a serving cell configuration associated with the serving cell. The RACH configuration may indicate RACH resources associated with the second set of SSBs. The RACH resources may indicate RACH occasions (ROs) and preambles associated with the second set of SSBs. In some aspects, the UE may determine an SSB pattern per SSB burst from the SSB position in burst IE in the RMSI, the serving cell configuration common IE, or the serving cell configuration associated with the serving cell. The SSB pattern per SSB burst may indicate TD locations of the third set of SSBs associated with the SSB burst. The third set of SSBs may be associated with the one or more repetitions of the first set of SSBs.

In some aspects, the UE may identify, via the RMSI, the serving cell configuration common IE, or the serving cell configuration associated with the serving cell, the RACH resource configuration with respect to the second set of SSBs (e.g., Set A beams/SSBs). The RACH resource configuration may indicate ROs and/or preambles associated with the second set of SSBs. In some aspects, the UE may identify, via the RMSI, the serving cell configuration common IE, or the serving cell configuration associated with the candidate serving cell, the SSB repetition pattern per SSB burst. The SSB repetition pattern per SSB burst may indicate TD locations of a third set of SSBs (e.g., as shown in FIG. 9) within the same SSB burst as the first set of SSBs. The third set of SSBs may be different from any of the first set of SSBs in terms of TD location or SSB index. For a certain SSB within the second set of SSBs, a Tx spatial filter for that SSB may be identical with at least one SSB of the first set of SSBs. The number of different SSBs in the first set of SSBs may be smaller than a maximum number of SSBs per SSB burst, which may enable an SSB burst specific beam repetition pattern.

In some aspects, the third set of SSBs may be different from the first set of SSBs in terms of TD location or SSB index. A number of SSBs associated with the first set of SSBs may be smaller than a maximum number of SSBs per SSB burst. The third set of SSBs may be associated with spatial domain repetitions of the first set of SSBs. TD locations associated with the third set of SSBs may be identified separately via the RMSI, the serving cell configuration common IE, or the serving cell configuration associated with the serving cell.

In some aspects, a control resource set (CORESET) (e.g., CORESET#0) identified from an SSB in the third set of SSBs may be identical to a CORESET identified from an SSB in the first set of SSBs, which may allow a UE backward compatibility and which may be based at least in part on a network node implementation. These two SSBs may include the same spatial Tx filter based at least in part on the SSB repetition pattern per SSB burst. A RACH configuration with respect to the first set of SSBs may not address any other SSBs in the second set of SSBs. In some aspects, the linkage information between the first set of SSBs and the second set of SSBs, the RACH resource configuration, and/or the SSB repetition pattern per SSB burst may be identified based at least in part on the serving cell configuration. The serving cell configuration may be UE-specifically configured instead of cell-common configured. An additional payload associated with such information may not be insignificant, and a capability of spatial beam prediction may be UE-specifically differentiated.

In some aspects, associations between the ROs, the preambles, and the second set of SSBs may be predefined. In some aspects, orthogonal ROs may be configured, in a TD and in an FD, between the first set of SSBs and the second set of SSBs based at least in part on an inability to receive SSB beams of the first set of SSBs and the second set of SSBs simultaneously. In some aspects, non-orthogonal ROs may be configured, in the TD and in the FD, between the first set of SSBs and the second set of SSBs based at least in part on an ability to receive SSB beams of the first set of SSBs and the second set of SSBs simultaneously.

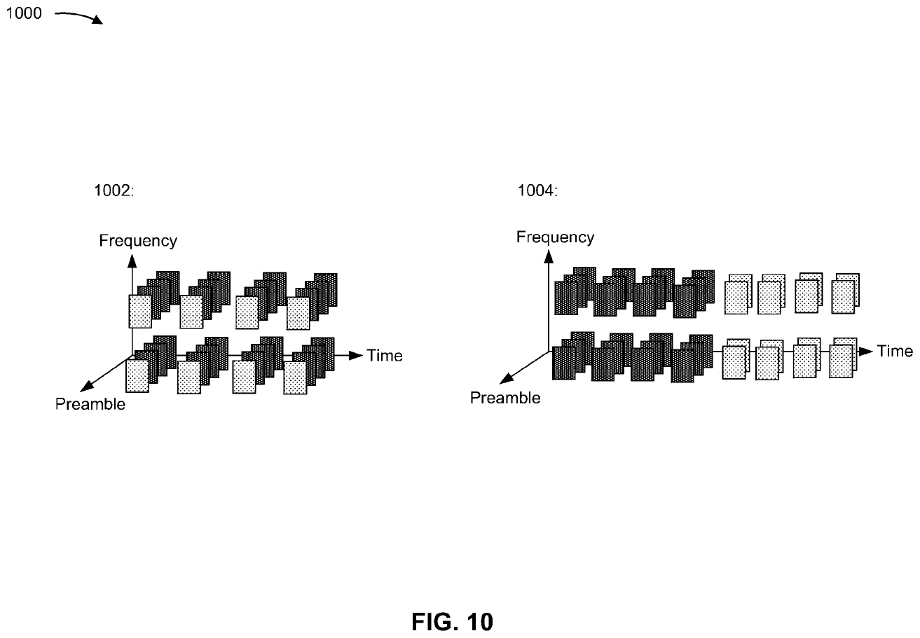

In some aspects, for the RACH resource configuration with respect to the second set of SSBs (e.g., Set A beams/SSBs), a signaling framework of ROs and preambles associated with the second set of SSBs (e.g., virtual and not actually transmitted SSBs) may be defined. A standard may predefine the associations between RO/preambles and the second set of SSBs, similar to those defined for actually transmitted SSBs (e.g., the first set of SSBs). Depending on a network node implementation, when beams in the first set of SSBs and the second set of SSBs cannot be received simultaneously, the network node may configure orthogonal ROs (e.g., in TD/FD) between the first set of SSBs and the second set of SSBs (e.g., as shown in FIG. 10). Depending on the network implementation, when the beams in the first set of SSBs and the second set of SSBs are able to be received simultaneously, the network node may configure non-orthogonal ROs (e.g., in TD/FD) between the first set of SSBs and the second set of SSBs (e.g., as shown in FIG. 10). Preambles may be differentiated between the first set of SSBs and the second set of SSBs.

In some aspects, a transmit spatial filter linkage may be configured between SSBs in the first set of SSBs and SSBs in the third set of SSBs. In some aspects, an SSB in the third set of SSBs may be configured with an SSB index that is associated with an SSB in the first set of SSBs, and such linked SSBs may be associated with a same transmit spatial filter. In some aspects, a number of SSBs in the third set of SSBs may correspond to a number of SSBs in the first set of SSBs. A determination of an SSB in the third set of SSBs having a same transmit spatial filter as an SSB in the first set of SSBs may be based at least in part on standard predefined rules.

In some aspects, the SSB repetition pattern per SSB burst may identify TD locations of the third set of SSBs within the SSB burst. For example, an alternative SSB position in burst IE, different from an SSB position in burst IE associated with the first set of SSBs, may be configured. As another example, an enhanced SSB position in burst IE may be configured, which may include an enhanced number of bits. A number of SSBs in the first set of SSBs may be represented by X, and a maximum number of SSBs per SSB burst may be represented by Y, where Y-X bits may be used by the enhanced SSB position in burst IE to identify the TD locations of the third set of SSBs.

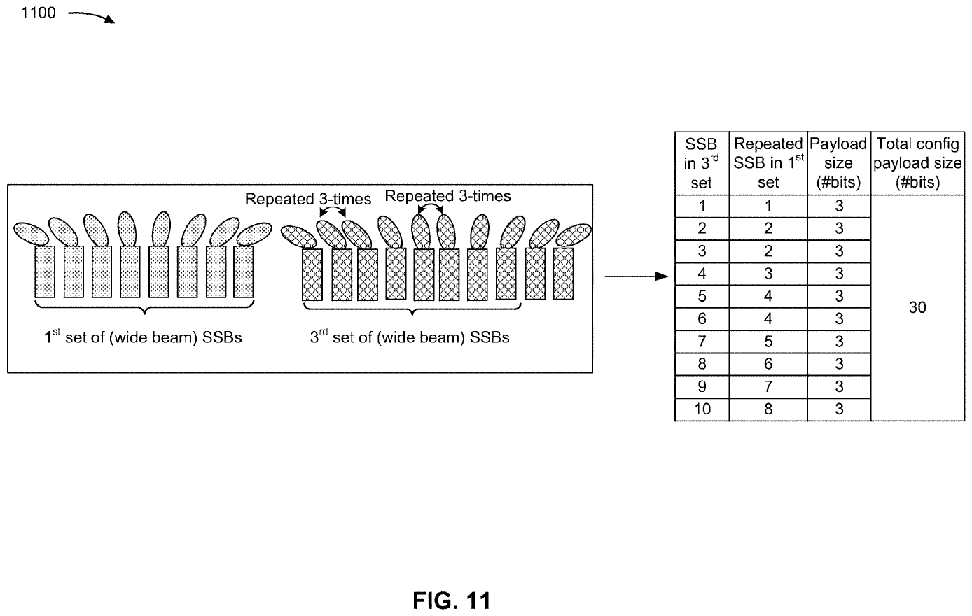

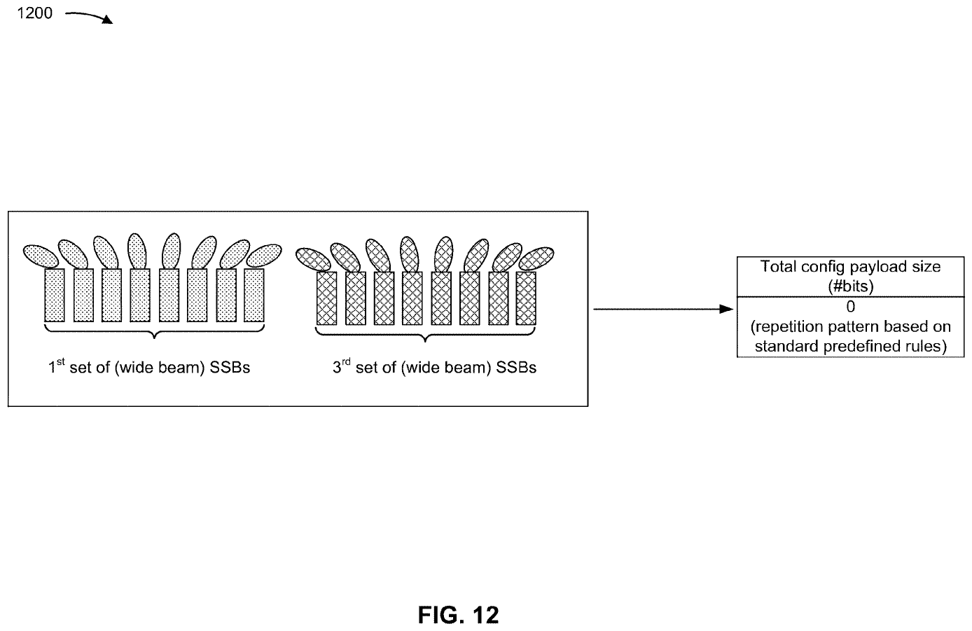

In some aspects, a Tx spatial filter linkage may be configured between SSBs in the first set of SSBs and the third set of SSBs. In a first option (e.g., as shown in FIG. 11), which may be associated with more flexibility but higher indication overhead as compared with a second option, each SSB in the third set of SSBs, as identified based at least in part on corresponding TD locations, may be configured with an SSB index associated with an SSB in the first set of SSBs, such that two linked SSBs may be associated with an identical Tx spatial filter. As an example, for X SSBs in the first set of SSBs and Z SSBs in the third set of SSBs, the total number of bits needed for such an indication may be [log₂ X]×Z. As another example, different SSBs in the first set of SSBs may have different numbers of repetitions in the third set of SSBs. In the second option (e.g., as shown in FIG. 12), which may be associated with less flexibility but lower indication overhead as compared with the first option, the standard may predefine that the number of SSBs in the third set of SSBs must be an integer multiple of SSBs in the first set of SSBs. The UE may determine which SSB in the first set of SSBs includes the same Tx spatial filter as a certain SSB in the third set of SSBs based at least in part on standard predefined rules. For example, SSBs in the first set of SSBs and the third set of SSBs may be re-indexed according to their TD locations, respectively. A number of SSBs in the third set of SSBs may be N times (where N is a positive integer) the number of SSBs in the first set of SSBs. In this case, the {(K−1)N+1, (K−1)N+2, . . . , (K−1)N+N}th SSBs in the third set of SSBs may include an identical spatial Tx filter as that of the Kth SSB in the first set of SSBs, where K is a positive integer, 1≤K≤X, and the first set of SSBs includes X SSBs).

As shown by reference number 710, the UE may determine, based at least in part on the measurements (e.g., wide beam measurements, which may be performed based at least in part on the SSB repetition pattern per burst), the linkage information and the RACH configuration, a predicted best SSB from the second set of SSBs and a RACH resource associated with the predicted best SSB. For example, the UE may provide the linkage information and the measurements as inputs to an AI/ML model, which may run on the UE. The UE may use the AI/ML model to determine the predicted best SSB (e.g., a predicted best narrow beam SSB) and an associated RACH resource. The predicted best SSB may be associated with the second set of SSBs. The AI/ML model may be trained, based at least in part on the linkage information, to output predicted best narrow beam SSBs based at least in part on measurements associated with wide beam SSBs.

As shown by reference number 712, the UE may transmit, to the network node, a RACH message based at least in part on the predicted best SSB and the RACH resource. The RACH message may be associated with an SCG setup. The SCG setup may be associated with relatively low latency and relatively low UE measurements, which may be based at least in part the linkage information, the RACH resource configuration, and/or the SSB repetition pattern per burst.

As indicated above, FIG. 7 is provided as an example. Other examples may differ from what is described with regard to FIG. 7.

FIG. 8 is a diagram illustrating an example 800 associated with using wide beam SSB measurements to predict narrow beam SSBs, in accordance with the present disclosure.

As shown in FIG. 8, a network node may transmit a plurality of SSB bursts, where each SSB burst may be associated with M₁/2 wide beams with two repetitions. The two repetitions may be in an SD. For example, a first SSB burst may be associated with M₁/2 wide beams with two repetitions, a second SSB burst may be associated with M₁/2 wide beams with two repetitions, and so on. A UE may perform M₁/2×N measurements (e.g., filtered L1-RSRP SSB measurements) over N/2 SSB cycles. The UE may identify appropriate Rx beams for each SSB burst of the plurality of SSB bursts (e.g., Rx#1 and Rx#2 for a first SSB burst, Rx#3 and Rx#4 for a second SSB burst, and Rx#(N−1) and Rx#N for a last SSB burst), which may be based at least in part on L1-RSRP SSB measurements. The UE may use a preconfigured linkage between wide beams and narrow beams, the L1-RSRP SSB measurements, and AI/ML at the UE to predict a best narrow beam SSB and an associated RACH resource. For example, the preconfigured linkage between wide beams and narrow beams and the L1-RSRP SSB measurements may be inputs to an AI/ML model that runs on the UE, which may output the predicted best narrow beam SSB and the associated RACH resource. The UE may transmit a RACH message, using the RACH resource, based at least in part on the predicted narrow beam SSB. In some aspects, employing an SSB burst specific beam repetition pattern (e.g., two repetitions per SSB burst, and an SSB burst that only includes wide beams and not narrow beams) may reduce latency and UE measurements by approximately 50%, which may improve an overall performance of the UE.

As indicated above, FIG. 8 is provided as an example. Other examples may differ from what is described with regard to FIG. 8.

FIG. 9 is a diagram illustrating an example 900 associated with using wide beam SSB measurements to predict narrow beam SSBs, in accordance with the present disclosure.

In some aspects, a RACH configuration for a relatively fast SCG setup via SD beam prediction may be employed. A network node may transmit a first set of SSBs. The first set of SSBs may be wide beam SSBs. The first set of SSBs may be actually transmitted SSBs, where TD locations associated with the actually transmitted SSBs may be identified via an SSB position in burst IE from RMSI or a serving cell configuration common IE.

As shown by reference number 902, a UE may determine linkage information between the first set of SSBs (e.g., Set B wide beam SSBs) and a second set of SSBs (e.g., Set A narrow beam SSBs). The second set of SSBs may be narrow beam SSBs. The second set of SSBs may be virtual and not actually transmitted SSBs. As shown by reference number 904, the UE may determine the RACH configuration, which may be for the second set of SSBs (e.g., the second set of virtual and not actually transmitted SSBs). The RACH configuration may indicate ROs and/or preambles associated with the second set of SSBs, which may be defined in terms of frequency and time. As shown by reference number 906, the UE may determine an SSB repetition pattern per SSB burst, which may indicate TD locations of a third set of SSBs together with repeated SSBs in the first set of SSBs. The first set of SSBs and the third set of SSBs may be associated with the same SSB burst. The third set of SSBs may be wide beam SSBs. The third set of SSBs may be spatial repetitions of the first set of SSBs, whose TD locations may be identified separately via RMSI, a serving cell configuration common IE, or a serving cell configuration.

In some aspects, the UE may use the linkage information, the RACH configuration, and the SSB repetition pattern per SSB burst to predict best second set SSBs (e.g., best narrow beam SSBs) for relatively fast SCG setup. For example, the UE may capture measurements associated with the first set of SSBs and the third set of SSBs. The UE may provide the linkage information and the captured measurements to an AI/ML model, which may output a best narrow beam SSB. The UE may determine a RACH resource associated with the best narrow beam SSB using the RACH configuration.

As indicated above, FIG. 9 is provided as an example. Other examples may differ from what is described with regard to FIG. 9.

FIG. 10 is a diagram illustrating an example 1000 associated with using wide beam SSB measurements to predict narrow beam SSBs, in accordance with the present disclosure.

As shown by reference number 1002, ROs configured for a first set of SSBs and a second set of SSBs may be non-orthogonal in TD/FD, which may be suitable for network nodes capable of digital Rx beamforming. Non-orthogonal ROs in TD/FD may be configured between the first set of SSBs and the second set of SSBs when beams in the first set of SSBs and the second set of SSBs are able to be received simultaneously.

As shown by reference number 1004, ROs configured for a first set of SSBs and a second set of SSBs may be orthogonal in TD/FD, which may be suitable for network nodes not capable of digital Rx beamforming. Orthogonal ROs in TD/FD may be configured between the first set of SSBs and the second set of SSBs when beams in the first set of SSBs and the second set of SSBs cannot be received simultaneously.

As indicated above, FIG. 10 is provided as an example. Other examples may differ from what is described with regard to FIG. 10.

FIG. 11 is a diagram illustrating an example 1100 associated with using wide beam SSB measurements to predict narrow beam SSBs, in accordance with the present disclosure.

As shown in FIG. 11, a first set of SSBs (e.g., wide beam SSBs) may include actually transmitted SSBs, whose TD locations may be identified via an SSB position in burst IE from RMSI or a serving cell configuration common IE. A third set of SSBs (e.g., wide beam SSBs) may include spatial repetitions of the first set of SSBs, whose TD locations are identified separately via RMSI, the serving cell configuration common IE, or a serving cell configuration. Each SSB in the third set of SSBs may be configured with an SSB index associated with an SSB in the first set of SSBs, such that two linked SSBs may be associated with an identical Tx spatial filter. Different SSBs in the first set of SSBs may have different numbers of repetitions in the third set of SSBs. For example, the first set of SSBs may include 8 SSBs, whereas the third set of SSBs may include 10 SSBs, which may be due to multiple repetitions in the third set of SSBs. An SSB in the third set of SSBs may be associated with a repeated SSB in the first set of SSBs and a payload size (e.g., a number of bits). Depending on a payload size for each SSB in the third set of SSBs, a total configuration payload size (e.g., a number of bits) may be calculated. Such an approach may be associated with more flexibility but a higher configuration overhead, and may be more suitable for an SSB repetition pattern per SSB burst identified through a UE-specifically-configured serving cell configuration.

As indicated above, FIG. 11 is provided as an example. Other examples may differ from what is described with regard to FIG. 11.

FIG. 12 is a diagram illustrating an example 1200 associated with using wide beam SSB measurements to predict narrow beam SSBs, in accordance with the present disclosure.

As shown in FIG. 12, a first set of SSBs (e.g., wide beam SSBs) may include actually transmitted SSBs, whose TD locations may be identified via an SSB position in burst IE from RMSI or a serving cell configuration common IE. A third set of SSBs (e.g., wide beam SSBs) may include spatial repetitions of the first set of SSBs, whose TD locations are identified separately via RMSI, the serving cell configuration common IE, or a serving cell configuration. A number of SSBs in the third set of SSBs may be the same as a number of SSBs in the first set of SSBs. A UE may determine which SSB in the first set of SSBs includes the same Tx spatial filter as a certain SSB in the third set of SSBs based at least in part on standard predefined rules. In other words, a repetition pattern may be based at least in part on the standard predefined rules, which may result in a total configuration payload size of zero bits. Such an approach may be associated with less flexibility but a lower configuration overhead, and may be suitable for an SSB repetition pattern per SSB burst identified through RMSI.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120) performs operations associated with using wide beam SSB measurements to predict narrow beam SSBs.

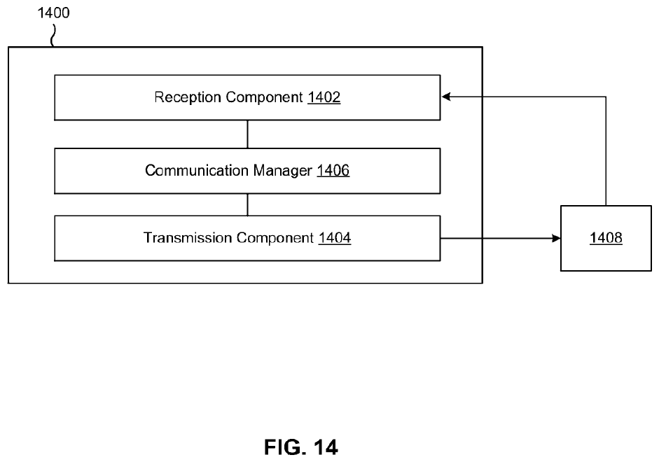

As shown in FIG. 13, in some aspects, process 1300 may include receiving a plurality of SSB bursts, wherein an SSB burst of the plurality of SSB bursts includes a first set of SSBs and one or more repetitions of the first set of SSBs (block 1310). For example, the UE (e.g., using reception component 1402 and/or communication manager 1406, depicted in FIG. 14) may receive a plurality of SSB bursts, wherein an SSB burst of the plurality of SSB bursts includes a first set of SSBs and one or more repetitions of the first set of SSBs, as described above.

As further shown in FIG. 13, in some aspects, process 1300 may include performing measurements associated with the plurality of SSB bursts (block 1320). For example, the UE (e.g., using communication manager 1406, depicted in FIG. 14) may perform measurements associated with the plurality of SSB bursts, as described above.

As further shown in FIG. 13, in some aspects, process 1300 may include determining linkage information between the first set of SSBs and a second set of SSBs, wherein the second set of SSBs are associated with resources not actually transmitted (block 1330). For example, the UE (e.g., using communication manager 1406, depicted in FIG. 14) may determine linkage information between the first set of SSBs and a second set of SSBs, wherein the second set of SSBs are associated with resources not actually transmitted, as described above.

As further shown in FIG. 13, in some aspects, process 1300 may include determining a RACH configuration associated with the second set of SSBs (block 1340). For the UE (e.g., using communication manager 1406, depicted in FIG. 14) may determine a RACH configuration associated with the second set of SSBs, as described above.

As further shown in FIG. 13, in some aspects, process 1300 may include determining, based at least in part on the measurements, the linkage information and the RACH configuration, a predicted best SSB from the second set of SSBs and a RACH resource associated with the predicted best SSB (block 1350). For example, the UE (e.g., using communication manager 1406, depicted in FIG. 14) may determine, based at least in part on the measurements, the linkage information and the RACH configuration, a predicted best SSB from the second set of SSBs and a RACH resource associated with the predicted best SSB, as described above.

As further shown in FIG. 13, in some aspects, process 1300 may include transmitting a RACH message based at least in part on the predicted best SSB and the RACH resource (block 1360). For example, the UE (e.g., using transmission component 1404 and/or communication manager 1406, depicted in FIG. 14) may transmit a RACH message based at least in part on the predicted best SSB and the RACH resource, as described above.

Process 1300 may include additional aspects, such as any single aspect or any combination of aspects described below and/or in connection with one or more other processes described elsewhere herein.

In a first aspect, the first set of SSBs are associated with wide beam SSBs and the second set of SSBs are associated with narrow beam SSBs.

In a second aspect, alone or in combination with the first aspect, the RACH message is associated with an SCG setup.

In a third aspect, alone or in combination with one or more of the first and second aspects, the first set of SSBs are associated with transmitted SSBs for a serving cell, and the first set of SSBs are identified via an SSB position in burst IE in RMSI or a serving cell configuration common IE associated with the serving cell.

In a fourth aspect, alone or in combination with one or more of the first through third aspects, process 1300 includes determining the linkage information from the SSB position in burst IE in the RMSI, the serving cell configuration common IE, or a serving cell configuration associated with the serving cell.

In a fifth aspect, alone or in combination with one or more of the first through fourth aspects, the second set of SSBs are associated with virtual resources that are not actually transmitted.

In a sixth aspect, alone or in combination with one or more of the first through fifth aspects, the linkage information indicates a linkage between the first set of SSBs and the second set of SSBs in terms of beam pointing directions, beam widths, or other implicit linkages.

In a seventh aspect, alone or in combination with one or more of the first through sixth aspects, process 1300 includes determining the RACH configuration from the SSB position in burst IE in the RMSI, the serving cell configuration common IE, or a serving cell configuration associated with the serving cell, wherein the RACH configuration indicates RACH resources associated with the second set of SSBs, and the RACH resources indicate ROS and preambles associated with the second set of SSBs.

In an eighth aspect, alone or in combination with one or more of the first through seventh aspects, process 1300 includes determining an SSB pattern per SSB burst from the SSB position in burst IE in the RMSI, the serving cell configuration common IE, or a serving cell configuration associated with the serving cell, wherein the SSB pattern per SSB burst indicates TD locations of a third set of SSBs associated with the SSB burst, and the third set of SSBs are associated with the one or more repetitions of the first set of SSBs.

In a ninth aspect, alone or in combination with one or more of the first through eighth aspects, the third set of SSBs are different from the first set of SSBs in terms of TD location or SSB index.

In a tenth aspect, alone or in combination with one or more of the first through ninth aspects, a number of SSBs associated with the first set of SSBs is smaller than a maximum number of SSBs per SSB burst.

In an eleventh aspect, alone or in combination with one or more of the first through tenth aspects, the third set of SSBs are associated with wide beams, the third set of SSBs are associated with SD repetitions of the first set of SSBs, and TD locations associated with the third set of SSBs are identified separately via the RMSI, the serving cell configuration common IE, or the serving cell configuration associated with the serving cell.

In a twelfth aspect, alone or in combination with one or more of the first through eleventh aspects, associations between the ROs, the preambles, and the second set of SSBs are predefined.

In a thirteenth aspect, alone or in combination with one or more of the first through twelfth aspects, orthogonal ROs are configured, in a TD and in a frequency domain, between the first set of SSBs and the second set of SSBs based at least in part on an inability to receive SSB beams of the first set of SSBs and the second set of SSBs simultaneously.

In a fourteenth aspect, alone or in combination with one or more of the first through thirteenth aspects, non-orthogonal ROs are configured, in a TD and in a frequency domain, between the first set of SSBs and the second set of SSBs based at least in part on an ability to receive SSB beams of the first set of SSBs and the second set of SSBs simultaneously.

In a fifteenth aspect, alone or in combination with one or more of the first through fourteenth aspects, a transmit spatial filter linkage is configured between SSBs in the first set of SSBs and SSBs in the third set of SSBs.

In a sixteenth aspect, alone or in combination with one or more of the first through fifteenth aspects, an SSB in the third set of SSBs is configured with an SSB index that is associated with an SSB in the first set of SSBs, and such linked SSBs are associated with a same transmit spatial filter.

In a seventeenth aspect, alone or in combination with one or more of the first through sixteenth aspects, a number of SSBs in the third set of SSBs corresponds to a number of SSBs in the first set of SSBs, and a determination of an SSB in the third set of SSBs having a same transmit spatial filter as an SSB in the first set of SSBs is based at least in part on standard predefined rules.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-12. Additionally, or alternatively, the apparatus 1400 may be configured to perform one or more processes described herein, such as process 1300 of FIG. 13. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive a plurality of SSB bursts, wherein an SSB burst of the plurality of SSB bursts includes a first set of SSBs and one or more repetitions of the first set of SSBs. The communication manager 1406 may perform measurements associated with the plurality of SSB bursts. The communication manager 1406 may determine linkage information between the first set of SSBs and a second set of SSBs, wherein the second set of SSBs are associated with resources not actually transmitted. The communication manager 1406 may determine a RACH configuration associated with the second set of SSBs. The communication manager 1406 may determine, based at least in part on the measurements, the linkage information and the RACH configuration, a predicted best SSB from the second set of SSBs and a RACH resource associated with the predicted best SSB. The transmission component 1404 may transmit a RACH message based at least in part on the predicted best SSB and the RACH resource.

The communication manager 1406 may determine the linkage information from the SSB position in burst in the RMSI, the serving cell configuration common, or a serving cell configuration associated with the serving cell. The communication manager 1406 may determine the RACH configuration from the SSB position in burst IE in the RMSI, the serving cell configuration common IE, or a serving cell configuration associated with the serving cell, wherein the RACH configuration indicates RACH resources associated with the second set of SSBs, and the RACH resources indicate RACH occasions (ROs) and preambles associated with the second set of SSBs. The communication manager 1406 may determine an SSB pattern per SSB burst from the SSB position in burst IE in the RMSI, the serving cell configuration common IE, or a serving cell configuration associated with the serving cell, wherein the SSB pattern per SSB burst indicates TD locations of a third set of SSBs associated with the SSB burst, and the third set of SSBs are associated with the one or more repetitions of the first set of SSBs.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a user equipment (UE), comprising: receiving a plurality of synchronization signal block (SSB) bursts, wherein an SSB burst of the plurality of SSB bursts includes a first set of SSBs and one or more repetitions of the first set of SSBs; performing measurements associated with the plurality of SSB bursts; determining linkage information between the first set of SSBs and a second set of SSBs, wherein the second set of SSBs are associated with resources not actually transmitted; determining a random access channel (RACH) configuration associated with the second set of SSBs; determining, based at least in part on the measurements, the linkage information and the RACH configuration, a predicted best SSB from the second set of SSBs and a RACH resource associated with the predicted best SSB; and transmitting a RACH message based at least in part on the predicted best SSB and the RACH resource.
Aspect 2: The method of Aspect 1, wherein the first set of SSBs are associated with wide beam SSBs and the second set of SSBs are associated with narrow beam SSBs.
Aspect 3: The method of any of Aspects 1-2, wherein the RACH message is associated with a secondary cell group (SCG) setup.
Aspect 4: The method of any of Aspects 1-3, wherein the first set of SSBs are associated with transmitted SSBs for a serving cell, and the first set of SSBs are identified via an SSB position in burst IE in remaining minimum system information (RMSI) or a serving cell configuration common IE associated with the serving cell.
Aspect 5: The method of Aspect 4, wherein determining the linkage information comprises determining the linkage information from the SSB position in burst IE in the RMSI, the serving cell configuration common IE, or a serving cell configuration associated with the serving cell.
Aspect 6: The method of any of Aspects 1-5, wherein the second set of SSBs are associated with virtual resources that are not actually transmitted.
Aspect 7: The method of any of Aspects 1-6, wherein the linkage information indicates a linkage between the first set of SSBs and the second set of SSBs in terms of beam pointing directions, beam widths, or other implicit linkages.
Aspect 8: The method of Aspect 4, further comprising: determining the RACH configuration from the SSB position in burst IE in the RMSI, the serving cell configuration common IE, or a serving cell configuration associated with the serving cell, wherein the RACH configuration indicates RACH resources associated with the second set of SSBs, and the RACH resources indicate RACH occasions (ROs) and preambles associated with the second set of SSBs.
Aspect 9: The method of Aspect 4, further comprising: determining an SSB pattern per SSB burst from the SSB position in burst IE in the RMSI, the serving cell configuration common IE, or a serving cell configuration associated with the serving cell, wherein the SSB pattern per SSB burst indicates time domain locations of a third set of SSBs associated with the SSB burst, and the third set of SSBs are associated with the one or more repetitions of the first set of SSBs.
Aspect 10: The method of Aspect 9, wherein the third set of SSBs are different from the first set of SSBs in terms of time domain location or SSB index.
Aspect 11: The method of Aspect 9, wherein a number of SSBs associated with the first set of SSBs is smaller than a maximum number of SSBs per SSB burst.
Aspect 12: The method of Aspect 9, wherein the third set of SSBs are associated with wide beams, the third set of SSBs are associated with SD repetitions of the first set of SSBs, and time domain locations associated with the third set of SSBs are identified separately via the RMSI, the serving cell configuration common IE, or the serving cell configuration associated with the serving cell.
Aspect 13: The method of Aspect 8, wherein associations between the ROs, the preambles, and the second set of SSBs are predefined.
Aspect 14: The method of Aspect 13, wherein orthogonal ROs are configured, in a time domain and in a frequency domain, between the first set of SSBs and the second set of SSBs based at least in part on an inability to receive SSB beams of the first set of SSBs and the second set of SSBs simultaneously.
Aspect 15: The method of Aspect 13, wherein non-orthogonal ROs are configured, in a time domain and in a frequency domain, between the first set of SSBs and the second set of SSBs based at least in part on an ability to receive SSB beams of the first set of SSBs and the second set of SSBs simultaneously.
Aspect 16: The method of Aspect 9, wherein a transmit spatial filter linkage is configured between SSBs in the first set of SSBs and SSBs in the third set of SSBs.
Aspect 17: The method of Aspect 16, wherein an SSB in the third set of SSBs is configured with an SSB index that is associated with an SSB in the first set of SSBs, and such linked SSBs are associated with a same transmit spatial filter.
Aspect 18: The method of Aspect 16, wherein a number of SSBs in the third set of SSBs corresponds to a number of SSBs in the first set of SSBs, and a determination of an SSB in the third set of SSBs having a same transmit spatial filter as an SSB in the first set of SSBs is based at least in part on standard predefined rules.
Aspect 19: An apparatus for wireless communication at a device, comprising a processor; memory coupled with the processor; and instructions stored in the memory and executable by the processor to cause the apparatus to perform the method of one or more of Aspects 1-18.
Aspect 20: A device for wireless communication, comprising a memory and one or more processors coupled to the memory, the one or more processors configured to perform the method of one or more of Aspects 1-18.
Aspect 21: An apparatus for wireless communication, comprising at least one means for performing the method of one or more of Aspects 1-18.
Aspect 22: A non-transitory computer-readable medium storing code for wireless communication, the code comprising instructions executable by a processor to perform the method of one or more of Aspects 1-18.
Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors coupled to the one or more memories, the one or more processors individually or collectively configured to:
receive a plurality of synchronization signal block (SSB) bursts, wherein an SSB burst of the plurality of SSB bursts includes a first set of SSBs and one or more repetitions of the first set of SSBs;
perform measurements associated with the plurality of SSB bursts;
determine linkage information between the first set of SSBs and a second set of SSBs, wherein the second set of SSBs are associated with resources not actually transmitted;
determine a random access channel (RACH) configuration associated with the second set of SSBs;
determine, based at least in part on the measurements, the linkage information and the RACH configuration, a predicted best SSB from the second set of SSBs and a RACH resource associated with the predicted best SSB; and
transmit a RACH message based at least in part on the predicted best SSB and the RACH resource.

2. The apparatus of claim 1, wherein the first set of SSBs are associated with wide beam SSBs and the second set of SSBs are associated with narrow beam SSBs.

3. The apparatus of claim 1, wherein the RACH message is associated with a secondary cell group (SCG) setup.

4. The apparatus of claim 1, wherein the first set of SSBs are associated with transmitted SSBs for a serving cell, and the first set of SSBs are identified via an SSB position in burst information element (IE) in remaining minimum system information (RMSI) or a serving cell configuration common IE associated with the serving cell.

5. The apparatus of claim 4, wherein the one or more processors, to determine the linkage information, are individually or collectively configured to:
determine the linkage information from the SSB position in burst IE in the RMSI, the serving cell configuration common IE, or a serving cell configuration associated with the serving cell.

6. The apparatus of claim 1, wherein the second set of SSBs are associated with virtual resources that are not actually transmitted.

7. The apparatus of claim 1, wherein the linkage information indicates a linkage between the first set of SSBs and the second set of SSBs in terms of beam pointing directions, beam widths, or other implicit linkages.

8. The apparatus of claim 4, wherein the one or more processors, to determine the RACH configuration, are individually or collectively configured to:
determine the RACH configuration from the SSB position in burst IE in the RMSI, the serving cell configuration common IE, or a serving cell configuration associated with the serving cell, wherein the RACH configuration indicates RACH resources associated with the second set of SSBs, and the RACH resources indicate RACH occasions (ROs) and preambles associated with the second set of SSBs.

9. The apparatus of claim 4, wherein the one or more processors are individually or collectively configured to:
determine an SSB pattern per SSB burst from the SSB position in burst IE in the RMSI, the serving cell configuration common IE, or a serving cell configuration associated with the serving cell, wherein the SSB pattern per SSB burst indicates time domain locations of a third set of SSBs associated with the SSB burst, and the third set of SSBs are associated with the one or more repetitions of the first set of SSBs.

10. The apparatus of claim 9, wherein the third set of SSBs are different from the first set of SSBs in terms of time domain location or SSB index.

11. The apparatus of claim 9, wherein a number of SSBs associated with the first set of SSBs is smaller than a maximum number of SSBs per SSB burst.

12. The apparatus of claim 9, wherein the third set of SSBs are associated with wide beams, the third set of SSBs are associated with spatial domain repetitions of the first set of SSBs, and time domain locations associated with the third set of SSBs are identified separately via the RMSI, the serving cell configuration common IE, or the serving cell configuration associated with the serving cell.

13. The apparatus of claim 8, wherein associations between the ROs, the preambles, and the second set of SSBs are predefined.

14. The apparatus of claim 13, wherein orthogonal ROs are configured, in a time domain and in a frequency domain, between the first set of SSBs and the second set of SSBs based at least in part on an inability to receive SSB beams of the first set of SSBs and the second set of SSBs simultaneously.

15. The apparatus of claim 13, wherein non-orthogonal ROs are configured, in a time domain and in a frequency domain, between the first set of SSBs and the second set of SSBs based at least in part on an ability to receive SSB beams of the first set of SSBs and the second set of SSBs simultaneously.

16. The apparatus of claim 9, wherein a transmit spatial filter linkage is configured between SSBs in the first set of SSBs and SSBs in the third set of SSBs.

17. The apparatus of claim 16, wherein an SSB in the third set of SSBs is configured with an SSB index that is associated with an SSB in the first set of SSBs, and such linked SSBs are associated with a same transmit spatial filter.

18. The apparatus of claim 16, wherein a number of SSBs in the third set of SSBs corresponds to a number of SSBs in the first set of SSBs, and a determination of an SSB in the third set of SSBs having a same transmit spatial filter as an SSB in the first set of SSBs is based at least in part on standard predefined rules.

19. A method of wireless communication performed by a user equipment (UE), comprising:
receiving a plurality of synchronization signal block (SSB) bursts, wherein an SSB burst of the plurality of SSB bursts includes a first set of SSBs and one or more repetitions of the first set of SSBs;
performing measurements associated with the plurality of SSB bursts;
determining linkage information between the first set of SSBs and a second set of SSBs, wherein the second set of SSBs are associated with resources not actually transmitted;
determining a random access channel (RACH) configuration associated with the second set of SSBs;
determining, based at least in part on the measurements, the linkage information and the RACH configuration, a predicted best SSB from the second set of SSBs and a RACH resource associated with the predicted best SSB; and
transmitting a RACH message based at least in part on the predicted best SSB and the RACH resource.

20-29. (canceled)

30. An apparatus for wireless communication, comprising:
means for receiving a plurality of synchronization signal block (SSB) bursts, wherein an SSB burst of the plurality of SSB bursts includes a first set of SSBs and one or more repetitions of the first set of SSBs;
means for performing measurements associated with the plurality of SSB bursts;
means for determining linkage information between the first set of SSBs and a second set of SSBs, wherein the second set of SSBs are associated with resources not actually transmitted;
means for determining a random access channel (RACH) configuration associated with the second set of SSBs;
means for determining, based at least in part on the measurements, the linkage information and the RACH configuration, a predicted best SSB from the second set of SSBs and a random access channel (RACH) resource associated with the predicted best SSB; and
means for transmitting a RACH message based at least in part on the predicted best SSB and the RACH resource.
